(19) United States
(12) Patent Application Publication
(10) Pub. No.: US 2018/0275552 A1
(43) Pub. Date: Sep. 27, 2018

(54) CHARGING ROLL FOR ELECTROPHOTOGRAPHIC DEVICE

(71) Applicant: Sumitomo Riko Company Limited, Aichi (JP)

(72) Inventors: Masanori Satoh, Aichi (JP); Yasuhide Watanabe, Aichi (JP); Masanori Ishida, Aichi (JP); Hiroshi Ukai, Aichi (JP); Yoshihiro Saito, Aichi (JP)

(73) Assignee: Sumitomo Riko Company Limited, Aichi (JP)

(21) Appl. No.: 15/990,707

(22) Filed: May 28, 2018

Related U.S. Application Data
(63) Continuation of application No. PCT/JP2017/027144, filed on Jul. 27, 2017.

(30) Foreign Application Priority Data
Sep. 30, 2016 (JP) 2016-193020
Feb. 28, 2017 (JP) 2017-035833

(51) Int. Cl. G03G 15/02; C09D 177/00; C09D 133/04; C09D 7/40

(52) U.S. Cl. CPC G03G 15/0233; C09D 177/00; C08K 3/36; C09D 7/69; G03G 2215/021; C09D 133/04

(57) ABSTRACT

Provided is a charging roll for an electrophotographic device in which charge capability is increased and uniformity of charging is satisfied. A charging roll for an electrophotographic device, the charging roll being provided with a shaft body, an elastic body layer formed on the outer periphery of the shaft body, and a surface layer formed on the outer periphery of the elastic body layer, the surface layer containing a binder resin, large-diameter particles having an average particle diameter of 15-50 μm, and small-diameter particles having an average particle diameter of 3 μm or more and less than 15 μm, the content of the small-diameter particles being within the range of 5-50 parts by mass with respect to 100 parts by mass of the binder resin, and the size of particle aggregates including the small-diameter particles contained in the surface layer being 6-50 μm.

### CROSS-REFERENCE TO RELATED APPLICATION

The present application is a continuation of PCT/JP2017/027144, filed on Jul. 27, 2017, and is related to and claims priority from Japanese patent application no. 2016-193020, filed on Sep. 30, 2016, and Japanese patent application no. 2017-035833, filed on Feb. 28, 2017. The entire contents of the aforementioned application are hereby incorporated by reference herein.

### TECHNICAL FIELD

The disclosure relates to a charging roll for an electrophotographic device suitably used in electrophotographic devices such as copying machines, printers, facsimiles, and the like employing an electrophotographic technique.

### BACKGROUND ART

In an electrophotographic device, as a method of charging a surface of a photosensitive drum, a contact charging method in which a charging roll is brought into direct contact with a surface of the photosensitive drum is known. In the contact charging method, if a discharge region is narrow, the charging is concentrated locally, which may cause image defects. Therefore, for example, as described in Patent Literature 1, particles are added to a surface layer of the charging roll to provide irregularities on the surface, and thereby the discharge region is secured and the amount of charging is maintained.

As a method of charging a charging roll, a direct current (DC) voltage application method is known from the viewpoint of compactness of a device, reduction in costs, and the like. In recent years, attempts have been made to employ a DC voltage application method for high-speed machines and highly functional machines. However, the DC voltage application method is inferior in chargeability as compared with an alternating current/direct current (AC/DC) superposed application method. In high-speed machines, since a contact time between a charging roll and a photosensitive drum is decreased, chargeability is deteriorated. In addition, since high image quality is required for high functional machines, uniformity is required in charging. For this reason, the conventional technology has not been able to support these machines.

### CITATION LIST

### Patent Literature

### [Patent Literature 1]

Japanese Laid-open Patent Application No. 2009-175427

### SUMMARY

The disclosure provides a charging roll for an electrophotographic device which increases charging performance and has uniformity of charging.

A charging roll for an electrophotographic device according to the disclosure includes a shaft body, an elastic body layer formed on an outer periphery of the shaft body, and a surface layer formed on an outer periphery of the elastic body layer, in which the surface layer contains a binder resin, large-diameter particles having an average particle diameter of 15 μm or more and 50 μm or less, and small-diameter particles having an average particle diameter of 3 μm or more and less than 15 μm, in which a content of the small-diameter particles is within a range of 5 to 50 parts by mass with respect to 100 parts by mass of the binder resin, and sizes of particle aggregates containing the small-diameter particles contained in the surface layer are 6 μm or more and 50 μm or less.

The surface layer preferably contains 0.1 to 10 parts by mass of an organic acid with respect to 100 parts by mass of the binder resin. The organic acid is preferably an organic acid having a hydroxyl group. A difference in average particle diameter between the large-diameter particles and the small-diameter particles is preferably 10 μm or more. An average distance between the small-diameter particles is preferably 40 μm or less. An average distance between the large-diameter particles is preferably 60 μm or more. A hardness of the large-diameter particles is preferably lower than a hardness of the small-diameter particles. The small-diameter particles are preferably silica particles.

### BRIEF DESCRIPTION OF DRAWINGS

FIG. 1A and FIG. 1B illustrates a schematic external view of a charging roll for an electrophotographic device according to one embodiment of the disclosure, and a cross-sectional view thereof taken along line A-A.

FIG. 2A and FIG. 2B are enlarged schematic views of the vicinity of a surface of the charging roll for an electrophotographic device illustrated in FIG. 1A and FIG. 1B.

### DESCRIPTION OF EMBODIMENTS

According to the charging roll for an electrophotographic device according to the disclosure, since the surface layer contains specific large-diameter particles and specific small-diameter particle, a content of the small-diameter particles is a specific amount, and sizes of the particle aggregates containing small-diameter particles is within a specific range, a sufficient gap between the surface layer and the photosensitive drum can be secured and discharge starting points can be uniformly secured. Thereby, a charging performance can be increased and adequate uniformity of charging can also be performed.

When the surface layer further contains an organic acid, this is better for preventing large-diameter particles from aggregating with each other. In addition, small-diameter particles can be efficiently disposed around large-diameter particles. Thereby, it is possible to restrict sizes of particle aggregates containing small-diameter particles to a small size. When the organic acid is an organic acid having a hydroxyl group, wear resistance, discharge resistance, and chargeability of the surface layer can be enhanced. When a difference in average particle diameter between the large-diameter particles and the small-diameter particles is 10 μm or more, both high chargeability and high uniformity can be achieved. When an average distance between small-diameter particles is 40 μm or less, the uniformity of charging is further improved. When an average distance between the large-diameter particles is 60 μm or more, the uniformity of charging is further improved. Also, when a hardness of the large-diameter particles is lower than a hardness of the small-diameter particles, contamination during sustained use is further reduced. When the small-diameter particles are silica particles, contamination during sustained use is further reduced.

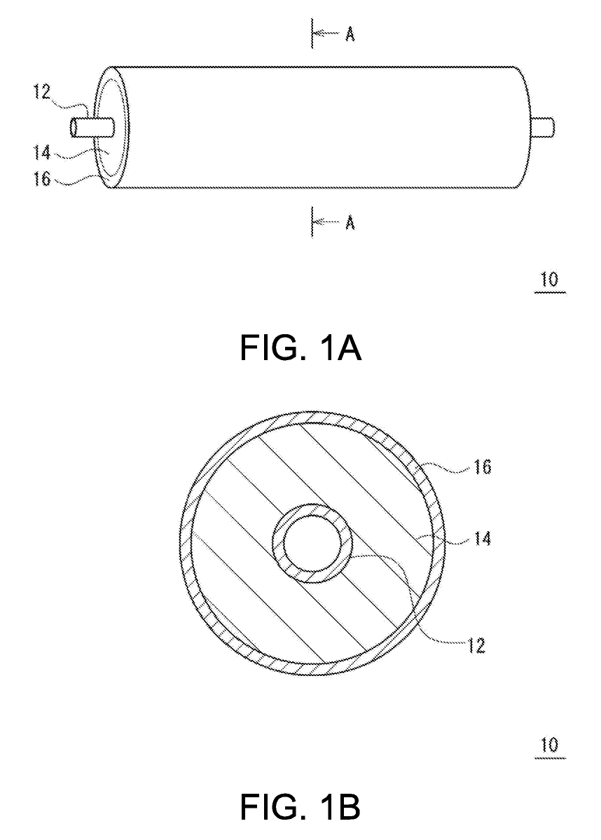

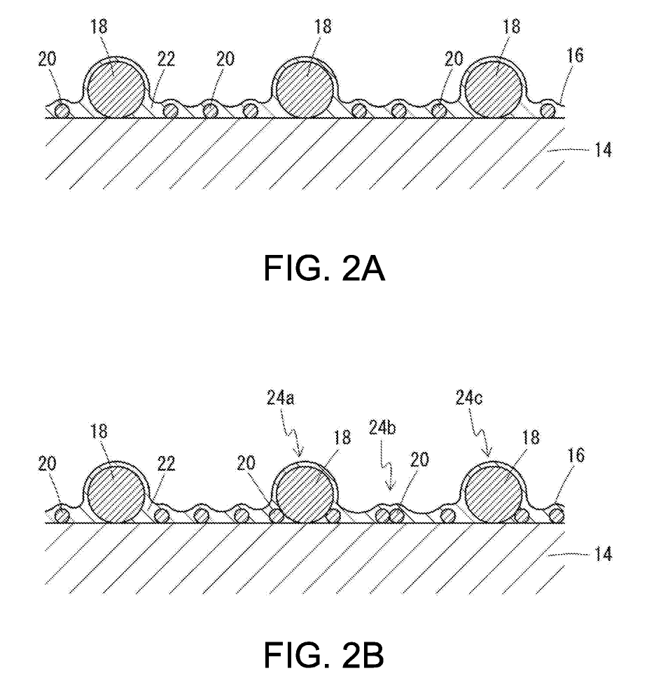

A charging roll for an electrophotographic device according to the disclosure (hereinafter may be simply referred to as a charging roll) will be described in detail. FIG. 1A and FIG. 1B illustrates a schematic external view of a charging roll for an electrophotographic device according to one embodiment of the disclosure, and a cross-sectional view thereof taken along line A-A. FIG. 2A and FIG. 2B are enlarged schematic views of the vicinity of a surface of the charging roll for an electrophotographic device illustrated in FIG. 1A and FIG. 1B.

A charging roll 10 includes a shaft body 12, an elastic body layer 14 formed on an outer periphery of the shaft body 12, and a surface layer 16 formed on an outer periphery of the elastic body layer 14. The elastic body layer 14 is a layer serving as a base of the charging roll 10. The surface layer 16 is a layer appearing on a surface of the charging roll 10.

The surface layer 16 contains a binder resin 22, large-diameter particles 18, and small-diameter particles 20. Irregularities are formed on a surface of the surface layer 16 due to the large-diameter particles 18 and the small-diameter particles 20. A portion in which each of the large-diameter particles 18 is present is a relatively large convex portion, and a portion in which each of the small-diameter particles 20 is present is a relatively small convex portion. One or more relatively small convex portions are disposed between relatively large convex portions. A relatively large convex portion in which the large-diameter particle 18 is present is a portion which comes into contact with a photosensitive drum, and a relatively small convex portion in which the small-diameter particle 20 is present is a portion which does not come in contact with the photosensitive drum. Shapes of the large-diameter particles 18 and the small-diameter particles 20 are not particularly limited, but a spherical shape, a shape of a true sphere, or the like is preferable.

The large-diameter particles 18 are particles having an average particle diameter of 15 μm or more and 50 μm or less. Due to such large-diameter particles 18 being contained, surface irregularities of the surface layer 16 are made sufficiently large, and a sufficient gap between the surface layer 16 and the photosensitive drum can be secured. Thereby, since discharge performance is enhanced, high chargeability can be secured. When an average particle diameter of the large-diameter particles 18 is less than 15 μm, a sufficient gap between the surface layer 16 and the photosensitive drum cannot be secured, and thus high chargeability cannot be secured. In addition, when the average particle diameter of the large-diameter particles 18 exceeds 50 μm, adequate uniformity of charging cannot be performed. The average particle diameter of the large-diameter particles 18 is more preferably 20 μm or more and still more preferably 25 μm or more from a viewpoint of being able to increase a gap between the surface layer and the photosensitive drum, or the like. In addition, the average particle diameter of the large-diameter particles 18 is more preferably 45 μm or less and still more preferably 40 μm or less from a viewpoint of easiness in enhancing uniformity of charging. The average particle diameter of the large-diameter particles 18 is a median diameter measured by a laser diffraction/scattering type particle diameter distribution measuring device.

The large-diameter particles 18 are not particularly limited, but resin particles are preferable from a viewpoint of easiness in securing flexibility at a contact portion with the photosensitive drum, or the like. For the resin particles, acrylic particles, urethane particles, polyamide particles, and the like can be exemplified. The large-diameter particles 18 may be constituted by one type of resin particles or two or more types of resin particles from these. Of these, acrylic particles are preferable from the viewpoint of allowing little warping due to a low deformation rate or the like. Also, polyamide particles (nylon particles) are preferable from a viewpoint of a low degree of influence on resistance.

From a viewpoint of easiness in maintaining the gap between the large-diameter particles 18 and the photosensitive drum or the like, it is preferable that an amount of deformation with respect to a load be small. For example, when a load of 50 mN is applied, an amount of deformation thereof is preferably 80% or less. It is more preferably 70% or less, and still more preferably 60% or less. On the other hand, from a viewpoint of securing flexibility or the like, the amount of deformation is preferably 10% or more. It is more preferably 20% or more.

A content of the large-diameter particles 18 is not particularly limited, but from viewpoints such as easiness in securing an appropriate interparticle distance between the large-diameter particles 18 and easiness in enhancing charging uniformity, the content of the large-diameter particles 18 is preferably within a range of 5 to 40 parts by mass with respect to 100 parts by mass of the binder resin 22. It is more preferably within a range of 5 to 35 parts by mass, and still more preferably within a range of 10 to 30 parts by mass.

An average distance between the large-diameter particles 18 is preferably 60 m or more. With an appropriate amount of the large-diameter particles 18, uniformity of charging is easily enhanced. From this perspective, the average distance between the large-diameter particles 18 is more preferably 80 μm or more, and still more preferably 100 μm or more. In addition, from viewpoints of an appropriate amount of the large-diameter particles 18 and easiness of enhancing the uniformity of charging, the average distance between the large-diameter particles 18 is preferably 300 μm or less. It is more preferably 250 μm or less, and still more preferably 200 μm or less. The average distance between the large-diameter particles 18 is expressed by an average of 15 points in total by capturing surface images of the surface layer 16 and measuring three respective distances between the large-diameter particles 18 at each of five arbitrary places. The distance between the large-diameter particles 18 is expressed by a distance between outer peripheries facing each other.

From a viewpoint of easiness in maintaining the gap between the surface layer and the photosensitive drum to be uniform or the like, it is preferable that a large-diameter particle 18 and another large-diameter particle 18 be present without forming an aggregate.

The small-diameter particles 20 are particles having an average particle diameter of 3 μm or more and less than 15 μm. Convex portions which are a portion in which the small-diameter particles 20 are present serve as discharge starting points. Due to the small-diameter particles 20 being contained, discharge starting points can be secured in the surface layer 16, and when the small-diameter particles 20 are dispersed, adequate uniformity of charging can be performed. When an average particle diameter of the small-diameter particles 20 is less than 3 m, convex portions which are a portion in which the small-diameter particles 20 are present are too small to be discharge starting points and adequate uniformity of charging cannot be performed. When the average particle diameter of the small-diameter particles 20 is more than 15 μm, the convex portions which are the portion in which the small-diameter particles 20 are present are too large to be discharge starting points and adequate uniformity of charging cannot be performed. From a viewpoint of enhancing uniformity of charging or the like, the average particle diameter of the small-diameter particles 20 is more preferably 4 μm or more, and still more preferably 5 μm or more. Also, it is more preferably 10 μm or less, and still more preferably 7 μm or less. The average particle diameter of the small-diameter particles 20 is a median diameter measured by a laser diffraction/scattering type particle diameter distribution measuring device.

Since the small-diameter particles 20 are disposed in a non-contact portion with respect to the photosensitive drum, resin particles having excellent flexibility may be used or relatively hard inorganic particles may be used. Among these, relatively hard inorganic particles are preferable from a viewpoint of increasing a difference in hardness with respect to the large-diameter particles 18 and allowing contamination to be reduced during sustained use or the like. Among inorganic particles, silica particles are particularly preferable from a viewpoint of further reducing contamination during sustained use.

A content of the small-diameter particles 20 is within a range of 5 to 50 parts by mass with respect to 100 parts by mass of the binder resin 22. When the content of the small-diameter particles 20 is less than 5 parts by mass, the number of discharge starting points decreases and adequate uniformity of charging cannot be performed. When the content of small-diameter particles 20 is more than 50 parts by mass, since particle aggregation containing the small-diameter particles 20 cannot be inhibited due to too many small-diameter particles 20 and the particle aggregates containing the small-diameter particles 20 become too large, adequate uniformity of charging cannot be performed. From the above viewpoint, the content of the small-diameter particles 20 is more preferably 10 parts by mass or more and still more preferably 15 parts by mass or more with respect to 100 parts by mass of the binder resin 22. Also, from the above viewpoint, the content is more preferably 40 parts by mass or less and still more preferably 30 parts by mass or less with respect to 100 parts by mass of the binder resin 22.

An average distance between the small-diameter particles 20 is preferably 40 μm or less. The smaller the average distance between the small-diameter particles 20, the easier it is to increase uniformity of charging. From this perspective, the average distance between the small-diameter particles 20 is more preferably 30 μm or less, and still more preferably 20 μm or less. The average distance between the small-diameter particles 20 is expressed by an average of 15 points in total by capturing surface images of the surface layer 16 and measuring three respective distances between the small-diameter particles 20 at five arbitrary places. The distance between the small-diameter particles 20 is expressed by a distance between outer peripheries facing each other.

The surface layer 16 may have no particle aggregates containing the small-diameter particles 20 as illustrated in FIG. 2A, but may also have particle aggregates containing the small-diameter particles 20 as illustrated in FIG. 2B. The particle aggregates containing the small-diameter particles 20 include particle aggregates containing both the small-diameter particles 20 and the large-diameter particles 18, and particle aggregates formed of only the small-diameter particles 20. For example, FIG. 2B illustrates each case of a particle aggregate 24b formed of two small-diameter particles 20 and one large-diameter particle 18, a particle aggregate 24b formed of two small-diameter particles 20, and a particle aggregate 24c formed of one small-diameter particle 20 and one large-diameter particle 18. When there are particle aggregates containing both of the small-diameter particles 20 and the large-diameter particles 18, the small-diameter particles 20 aggregated with each other and the large-diameter particles 18 aggregated with each other are inhibited, and thus it is easy to appropriately disperse the small-diameter particles 20 and the large-diameter particles 18. When particle aggregates formed of only the small-diameter particles 20 are present, this is preferable in terms of discharge control.

Sizes of particle aggregates containing the small-diameter particles 20 are 6 μm or more and 50 μm or less. Since then the particles have excellent dispersibility, adequate uniformity of charging can be performed. When the size of aggregate exceeds 50 μm, dispersibility of particles is poor and adequate uniformity of charging cannot be performed. From this perspective, the size of the aggregates is preferably 45 μm or less, and still more preferably 40 μm or less. The particle aggregate containing the small-diameter particles 20 is an aggregation of particles gathered on a surface along the surface of the elastic body layer 14, and there are few aggregates in a thickness direction due to an amount, thickness, and the like of the binder resin 22. A size of the particle aggregate containing the small-diameter particles 20 is expressed by an average of 15 points in total by capturing surface images of the surface layer 16 and measuring three maximum distances of particle aggregates containing the small-diameter particles 20 at each of five arbitrary places.

A difference in average particle diameter between the large-diameter particles 18 and the small-diameter particle 20 is preferably 10 μm or more. The larger the difference in average particle diameter, the larger the surface irregularities of the surface layer 16, and the easier it is to secure a gap between the surface layer 16 and the photosensitive drum. From this perspective, the difference in average particle diameter is more preferably 15 μm or more, and still more preferably 20 μm or more.

A hardness of the large-diameter particle 18 is preferably lower than a hardness of the small-diameter particle 20. The larger the difference in hardness is, the easier it is to allow contamination to be reduced during sustained use. From this perspective, a relationship between a hardness a of the large-diameter particle 18 and a hardness b of the small-diameter particle 20 is preferably a/b<1. It is more preferably a/b≤0.7, still more preferably a/b≤0.6, and particularly preferably a/b≤0.5.

In the surface layer 16, a height of the convex portion at a portion in which the large-diameter particles 18 are present is preferably 10 μm or more. It is more preferably 15 μm or more, and still more preferably 20 μm or more. When the height of the convex portion is 10 μm or more, a gap between the surface layer and the photosensitive drum is easily secured. In addition, a height of the convex portion at a portion in which the small-diameter particles 20 are present is preferably 2.0 μm or more. It is more preferably 2.5 μm or more, and still more preferably 3.0 μm or more. When the height of the convex portion is 2.0 μm or more, discharge starting points are easily secured. The height of the convex portion is expressed by a height from a surface of the surface layer 16 at a portion in which no particle is present (for example, a portion between a small-diameter particle 20 and another small-diameter particle 20, or the like). The height of the convex portion can be measured by observing a cross section using a laser microscope (for example, a “VK-9510” manufactured by Keyence Corporation or the like). For example, it can be expressed by an average of respective heights of the convex portions measured at five arbitrary positions.

The binder resin 22 is not particularly limited, and a suitable material may be selected in accordance with required characteristics and the like. As a binder, acrylic resins, methacrylic resins, fluorine-based resins, silicone-based resins, polycarbonate-based resins, urethane-based resins, polyamide-based resins, and the like are examples. These may be used singly or in combination of two or more kinds for the binder resin 22 of the surface layer 16. Of these, from viewpoints of resistance control, flexibility, or the like, polyamide-based resins and acrylic resins are more preferable. In addition, from a viewpoint of adhesion to particles or the like, the binder resin 22 is preferably made of the same material as the particles.

The surface layer 16 may contain an organic acid in addition to the binder resin 22, the large-diameter particles 18, and the small-diameter particle 20. In a surface layer forming composition, the organic acid is ionized. Since the ionized organic acid is present around particles, a negative charge of the organic acid can be imparted to the particles. Since the large-diameter particles 18 having a larger surface area have more negative charges than the small-diameter particles 20, electrostatic repulsion tends to occur between the large-diameter particles 18. Therefore, when the surface layer 16 further contains the organic acid, this is thought that the surface layer 16 is better in an effect for preventing the large-diameter particles 18 from aggregating with each other. On the other hand, since the small-diameter particle 20 has less negative charge than the large-diameter particle 18, electrostatic repulsion between the large-diameter particle 18 and the small-diameter particle 20 is small, and the large-diameter particle 18 and the small-diameter particle 20 can aggregate due to a difference in van der Waals force. Therefore, when the surface layer 16 further contains the organic acid, it is thought that the small-diameter particles 20 can be efficiently disposed around the large-diameter particles 18. In addition, due to electrostatic repulsion between the small-diameter particles 20, the number of small-diameter particles 20 disposed around the large-diameter particles 18 becomes small. As described above, when the surface layer 16 further contains the organic acid, sizes of the particle aggregates containing the small-diameter particles 20 can be restricted to be small.

As the organic acid, a carboxylic acid, a sulfonic acid, and the like can be exemplified. As the carboxylic acid, citric acid, oxalic acid, acetic acid, formic acid, and the like can be exemplified. These may be used singly or in combination of two or more kinds for the organic acid added to the surface layer 16. Of these, carboxylic acids are preferable, and organic acids having a hydroxyl group such as citric acid and oxalic acid are particularly preferable. When the organic acid is an organic acid having the hydroxyl group, wear resistance, discharge resistance, and chargeability of the surface layer 16 can be enhanced. The reason for this is thought to be that the hydroxyl group of the organic acid tends to hydrogen-bond with an amide group of nylon which is a binder resin, a carbonyl group of acrylic resins, or the like, and thus wear resistance and discharge resistance of the surface layer 16 are enhanced by interaction due to the hydrogen bonding. Further, the reason for this is thought to be that chargeability is enhanced due to increased electrostatic capacity of the surface layer 16 due to the hydroxyl group of the organic acid.

An organic acid content is preferably 0.1 parts by mass or more with respect to 100 parts by mass of the binder resin from viewpoints of being better in the effect for preventing the large-diameter particles 18 from aggregating with each other, causing the small-diameter particles 20 to be efficiently disposed around the large-diameter particles 18, restricting the size of the particle aggregates containing the small-diameter particles 20 to be small, and the like. It is more preferably 0.5 parts by mass or more. Also, the organic acid content is preferably 10 parts by mass or less with respect to 100 parts by mass of the binder resin from a viewpoint of compatibility of an organic acid or a diluted solution of the organic acid in the surface layer forming composition. It is more preferably 7 parts by mass or less.

The surface layer 16 may or may not contain additives in addition to the binder resin 22, the large-diameter particles 18, and the small-diameter particle 20. Regarding an additive, a conductive agent, a stabilizing agent, an ultraviolet absorbing agent, a lubricant, a releasing agent, a dye, a pigment, a flame retardant, and the like are examples. As the conductive agent, an ion conductive agent (such as quaternary ammonium salt), an electron conductive agent (such as a carbon black), and the like are examples.

The surface layer 16 can be adjusted to have a predetermined volume resistivity depending on types of materials, mixing in of conductive agents, and the like. The volume resistivity of the surface layer 16 may be appropriately set in a range of 10⁵ to 10¹¹ Ω·cm, 10⁸ to 10¹⁰ Ω·cm, or the like depending on applications or the like.

A thickness of the surface layer 16 is expressed by a thickness at a portion in which no particle is present (for example, a portion between a small-diameter particle 20 and another small-diameter particle 20, or the like). The thickness of the surface layer 16 is preferably 1.0 μm or more from a viewpoint of easiness in fixing sufficient large-diameter particles 18 and small-diameter particle 20 in the surface layer or the like. It is more preferably 1.5 μm or more. On the other hand, it is preferably 3.0 μm or less from a viewpoint of easiness in securing discharge starting points or the like by securing sizes of the convex portions at a portion in which the small-diameter particles 20 are present. It is more preferably 2.5 μm or less. The thickness of the surface layer 16 can be measured by observing a cross section using a laser microscope (for example, a “VK-9510” manufactured by Keyence Corporation or the like). For example, it can be expressed by an average of respective distances from the surface of the elastic body layer 14 to the surface of the surface layer 16 measured at five arbitrary positions.

The surface layer 16 can be formed using the surface layer forming composition containing the binder resin 22, the large-diameter particles 18 and the small-diameter particles 20, by applying it onto the peripheral surface of the elastic body layer 14, and by appropriately performing a drying treatment or the like. In the surface layer forming composition, the binder resin 22, the large-diameter particles 18, and the small-diameter particles 20 can be prepared as a liquid dispersion using a dispersing medium. Ketone-based solvents such as methyl ethyl ketone (MEK) and methyl isobutyl ketone, alcohol-based solvents such as isopropyl alcohol (IPA), methanol, and ethanol, hydrocarbon-based solvents such as hexane and toluene, acetate-based solvents such as ethyl acetate and butyl acetate, ether-based solvents including diethyl ether, tetrahydrofuran, or the like, water, and the like are examples of a dispersing medium.

It is preferable that particles be sufficiently dispersed before the surface layer forming composition being coated. For example, by irradiating the surface layer forming composition with ultrasonic waves, the particles can be sufficiently dispersed before the surface layer forming composition is coated. In addition, the surface layer forming composition containing an organic acid can have sufficiently dispersed particles due to electrostatic interaction thereof before being coated. In the surface layer forming composition containing an organic acid, the step of irradiating with ultrasonic waves can be omitted or shortened.

The elastic body layer 14 contains a crosslinked rubber. The elastic body layer 14 is formed of a conductive rubber composition containing a non-crosslinked rubber. The crosslinked rubber is obtained by crosslinking the non-crosslinked rubber. The non-crosslinked rubber may be a polar rubber or a nonpolar rubber. From a viewpoint of excellent conductivity or the like, the non-crosslinked rubber is more preferably a polar rubber.

A polar rubber is a rubber having a polar group, and a chloro group, a nitrile group, a carboxyl group, an epoxy group, and the like can be exemplified as the polar group. As the polar rubber, specifically, hydrin rubber, nitrile rubber (NBR), urethane rubber (U), acrylic rubber (copolymer of acrylic acid ester and 2-chloroethyl vinyl ether, ACM), chloroprene rubber (CR), an epoxidized natural rubber (ENR), and the like can be exemplified. Among the polar rubbers, hydrin rubber and nitrile rubber (NBR) are more preferable from the viewpoint that volume resistivity tends to be particularly low, or the like.

As the hydrin rubber, epichlorohydrin homopolymer (CO), epichlorohydrin-ethylene oxide binary copolymer (ECO), epichlorohydrin-allyl glycidyl ether binary copolymer (GCO), epichlorohydrin-ethylene oxide-allyl glycidyl ether ternary copolymer (GECO), and the like can be exemplified.

As the urethane rubber, polyether type urethane rubber having an ether bond in a molecule can be exemplified. The polyether type urethane rubber can be produced by a reaction of polyether having hydroxyl groups at opposite ends and diisocyanate. As the polyether, although not particularly limited, polyethylene glycol, polypropylene glycol, and the like can be exemplified. As the diisocyanate, although not particularly limited, tolylene diisocyanate, diphenylmethane diisocyanate, and the like can be exemplified.

As the nonpolar rubber, isoprene rubber (IR), natural rubber (NR), styrene-butadiene rubber (SBR), butadiene rubber (BR), and the like, are examples.

As the crosslinking agent, a sulfur crosslinking agent, a peroxide crosslinking agent, and a dechlorination crosslinking agent can be exemplified. These crosslinking agents may be used singly or in combination of two or more kinds thereof.

As the sulfur crosslinking agent, conventionally known sulfur crosslinking agents such as powdered sulfur, precipitated sulfur, colloidal sulfur, surface-treated sulfur, insoluble sulfur, sulfur chloride, a thiuram-based vulcanization accelerator, a polymeric polysulfide, and the like can be exemplified.

As the peroxide crosslinking agent, conventionally known peroxide crosslinking agents such as a peroxyketal, a dialkyl peroxide, a peroxyester, a ketone peroxide, a peroxydicarbonate, a diacyl peroxide, a hydroperoxide, and the like can be exemplified.

As the dechlorination crosslinking agent, dithiocarbonate compounds can be exemplified. More specifically, quinoxaline-2,3-dithiocarbonate, 6-methylquinoxaline-2,3-dithiocarbonate, 6-isopropylquinoxaline-2,3-dithiocarbonate, 5,8-dimethylquinoxaline-2,3-dithiocarbonate, and the like can be exemplified.

A formulation amount of the crosslinking agent is, from a viewpoint that bleeding cannot easily occur or the like, preferably within a range of 0.1 to 2 parts by mass, more preferably within a range of 0.3 to 1.8 parts by mass, and still more preferably within a range of 0.5 to 1.5 parts by mass with respect to 100 parts by mass of the non-crosslinked rubber.

When a dechlorination crosslinking agent is used as the crosslinking agent, a dechlorination crosslinking accelerator may be used in combination. As the dechlorination crosslinking accelerator, 1,8-diazabicyclo(5,4,0)undecene-7 (hereinafter abbreviated as DBU) or its weak acid salt can be exemplified. Although the dechlorination crosslinking accelerator may be used in a form of DBU, it is preferably used in a form of its weak acid salt from the perspective of handling. As the weak acid salt of DBU, a carbonate, stearate, 2-ethylhexylate, benzoate, salicylate, 3-hydroxy-2-naphthoate, phenol resin salt, 2-mercaptobenzothiazole salt, 2-mercaptobenzimidazole salt, and the like can be exemplified.

A dechlorination crosslinking accelerator content is, from a viewpoint that bleeding cannot easily occur or the like, preferably in a range of 0.1 to 2 parts by mass with respect to 100 parts by mass of the non-crosslinked rubber. It is more preferably in a range of 0.3 to 1.8 parts by mass, and still more preferably in a range of 0.5 to 1.5 parts by mass.

In order to impart conductivity, conventionally known conductive agents such as carbon black, graphite, c-TiO₂, c-ZnO, c-SnO₂ (c- means conductivity), an ion conductive agent (quaternary ammonium salt, borate, surfactant, or the like), and the like can be appropriately added to the elastic body layer 14. In addition, various types of additive may be appropriately added as necessary. As the additives, a lubricant, a vulcanization accelerator, an anti-aging agent, a light stabilizer, a viscosity modifier, a processing aid, a flame retardant, a plasticizer, a foaming agent, a filler, a dispersant, a defoaming agent, a pigment, a mold-releasing agent, and the like can be exemplified.

The elastic body layer 14 can be adjusted to have a predetermined volume resistivity depending on types of crosslinked rubbers, a formulation amount of the ion conductive agent, mixing in of the electron conductive agent, and the like. The volume resistivity of the elastic body layer 14 may be appropriately set in a range of 10² to 10¹⁰ Ω·cm, 10³ to 10⁹ Ω·cm, 10⁴ to 10⁸ Ω·cm, or the like depending on applications or the like.

A thickness of the elastic body layer 14 is not particularly limited, and may be appropriately set within a range of 0.1 to 10 mm or the like depending on applications or the like.

The elastic body layer 14 can be manufactured as follows, for example. First, the shaft body 12 is coaxially installed in a hollow portion of a roll forming die, and a non-crosslinked conductive rubber composition is injected therein, heated, cured (crosslinked), and then is removed from the die to form the elastic body layer 14 on the outer periphery of the shaft body 12, or the elastic body layer 14 is formed on the outer periphery of the shaft body 12 by extrusion-molding the non-crosslinked conductive rubber composition on the surface of the shaft body 12.

The shaft body 12 is not particularly limited as long as it has conductivity. Specifically, a solid body made of a metal such as iron, stainless steel, aluminum or the like, a metal core made as a hollow body, and the like can be exemplified. The surface of the shaft body 12 may be coated with adhesives, primers, or the like as necessary. That is, the elastic body layer 14 may be adhered to the shaft body 12 via an adhesive layer (primer layer). Conductivity may be imparted to adhesives, primers, and the like as necessary.

According to the charging roll 10 having the configuration described above, when the surface layer 16 contains specific large-diameter particles 18 and specific small-diameter particles 20, a content of the small-diameter particles 20 is a specific amount, and sizes of particle aggregates containing the small-diameter particles 20 are set to a specific range, a sufficient gap between the surface layer and the photosensitive drum can be secured and discharge starting points can be uniformly secured. Thereby, it is possible to enhance charging performance and perform adequate uniformity of charging.

A configuration of the charging roll according to the disclosure is not limited to the configuration illustrated in FIG. 1A and FIG. 1B. For example, in the charging roll 10 illustrated in FIG. 1A and FIG. 1B, another elastic body layer may be provided between the shaft body 12 and the elastic body layer 14. In this case, the other elastic body layer is a layer serving as a base of the charging roll, and the elastic body layer 14 functions as a resistance adjusting layer or the like for adjusting resistance of the charging roll. Another elastic body layer can be formed of any of the materials exemplified for the materials constituting the elastic body layer 14, for example. Further, for example, in the charging roll 10 illustrated in FIG. 1A and FIG. 1B, another elastic body layer may be provided between the elastic body layer 14 and the surface layer 16. In this case, the elastic body layer 14 is a layer serving as a base of the charging roll, and another elastic body layer functions as a resistance adjusting layer or the like for adjusting resistance of the charging roll.

### EXAMPLES

Hereinafter, the disclosure will be described in detail using examples and comparative examples.

### Examples 1 to 11, Comparative Examples 1 to 8

### <Preparation of Conductive Rubber Composition>

30 parts by mass of carbon black, 6 parts by mass of zinc oxide, 2 parts by mass of stearic acid, 1 part by mass of sulfur, 0.5 parts by mass of thiazole-based vulcanization accelerator, 0.5 parts by mass of thiuram-based vulcanization accelerator, and 50 parts by mass of heavy calcium carbonate were mixed in with respect to 100 parts by mass of isoprene rubber, kneaded for 10 minutes using a closed type mixer whose temperature was adjusted to 50° C., and thereby a conductive rubber composition was prepared.

The following materials were prepared as materials for the conductive rubber composition.
Rubber component

Isoprene rubber (IR) [manufactured by JSR Corporation, “JSRIR 2200” ]
Conductive agent

Carbon black (electron conductive agent) [“Show Black N762” manufactured by Cabot Japan KK]
Zinc oxide [“Zinc oxide 2 types” manufactured by “Sakai Chemical Industry Co., Ltd.” ]
Stearic acid [“Stearic acid cherry” manufactured by NOF Corporation]
Sulfur [“Powdered sulfur” manufactured by Tsurumi Chemical Industry Co., Ltd.]
Vulcanization accelerator

Thiazole-based vulcanization accelerator [“Nocceler DM” manufactured by Ouchi Shinko Chemical Industrial Co., Ltd.]

Thiuram-based vulcanization accelerator [“Nocceler TRA” manufactured by Ouchi Shinko Chemical Industry Co., Ltd.]
Inorganic filler particles

Heavy calcium carbonate [“Whiton B” manufactured by Shiraishi Calcium Co., Ltd., average particle diameter: 3.6 μm]

### <Manufacturing of Elastic Body Layer>

A prepared conductive rubber composition was extruded into a crown shape, using an extrusion molding apparatus, on an outer periphery of a metal core made of free-cutting steel (SUM) having a diameter of 6 mm. Specifically, while causing the metal core to pass through a circular mouth portion of a die of the extrusion molding apparatus, by supplying the conductive rubber composition to a gap between the die and the metal core, an elastic body layer was extruded on the outer periphery of the metal core. In this extrusion molding, a precursor of the elastic body layer was formed into a crown shape by changing a passage speed of the metal core and controlling an amount of the conductive rubber composition adhered to the metal core in a longitudinal direction. Next, this was heat-treated at 180° C. for 30 minutes. As a result, a predetermined elastic body layer (thickness: 1.5 mm) was formed on the outer periphery of the metal core.

### <Manufacturing of Surface Layer>

A liquid composition for forming a surface layer was prepared so that formulation amounts (parts by mass) shown in Tables 1 and 2 were obtained by mixing particles and a binder resin, adding 200 parts by mass of methyl ethyl ketone (MEK), and mixing and agitating with ultrasonic waves being applied for a predetermined time. Next, this liquid composition was roll-coated on an outer peripheral surface of the elastic body layer and subjected to a heat treatment to form a surface layer on the outer periphery of the elastic body layer. Thereby, a charging roll was manufactured.

### Examples 12 to 18

A liquid composition for forming a surface layer was prepared so that a formulation amounts (parts by mass) shown in Table 3 was obtained by mixing particles, a binder resin, and an organic acid solution, adding 200 parts by mass of methyl ethyl ketone (MEK), and mixing and agitating (10 minutes). At this time, ultrasonic waves were not applied. A charging roll was manufactured in the same manner as in other examples except that the obtained surface layer forming composition was used.

Materials used as surface layer materials were as follows.
Binder resin (Nylon): “Fine Resin FR-104” manufactured by Namariichi Co., Ltd.
Binder resin (acryl): “Paracron W197C” manufactured by Negami Chemical Industrial Co., Ltd.
Nylon particles <1>: Average particle diameter 30 μm, “DAIAMID 1118” manufactured by Daicel-Hils
Nylon particles <2>: Average particle diameter 20 μm, “DAIAMID 2158” manufactured by Daicel-Hiils
Nylon particles <3>: Average particle diameter 50 μm, “ORGASOL 2002 ES 5 NAT 1” manufactured by Arkema
Nylon particles <4>: Average particle diameter: 5.0 μm, “DAIAMID 2070” manufactured by Daicel-Hills
Nylon particles <5>: Average particle diameter 10 μm, “DAIAMID 2159” manufactured by Daicel-Hils
Nylon particles <6>: Average particle diameter 60 μm, “ORGASOL 2002 ES 6 NAT 1” manufactured by Arkema
Silica particles <1>: Average particle diameter 5.0 μm, “Sylysia 450” manufactured by Fuji Silysia
Silica particles <2>: Average particle diameter 3.0 μm, “SUNSPHERE L-31” manufactured by AGC Si-Tech Co., Ltd.
Silica particles <3>: Average particle diameter 12 μm, “SUNSPHERE H-122” manufactured by AGC Si-Tech Co., Ltd.
Silica particles <4>: Average particle diameter 2.0 μm, “Sylysia 436” manufactured by Fuji Silysia
Organic acid <1>: Citric acid, a 5% by mass aqueous solution of citric acid was used.
Organic acid <2>: Oxalic acid, a 5% by mass of aqueous solution oxalic acid was used.
Organic acid <3>: Formic acid, a 5% by mass of aqueous solution formic acid was used.
Organic acid <4>: Acetic acid, a 5% by mass of aqueous solution acetic acid was used.

In this case, the formulation amounts in the table are amounts excluding water.

Respective measurements were conducted for the particles used. Further, measurements were conducted for each of the surface layers of the charging rolls manufactured. Then, image evaluation relating to chargeability was conducted for each of the charging rolls manufactured. In addition, durability was also evaluated. For Examples 1, 7 and 12 to 18, the number of aggregates formed of large-diameter particles was investigated and image evaluation after durability was further conducted. Evaluation results and compositional formulations for the surface layer forming compositions are shown in the following table.

### (Hardness Ratio of Particles)

Using a “FISCHERSCOPE HM 2000 LT” manufactured by Fischer Technology Inc. or a comparable measuring instrument and using a flat indenter as a touch tip, a universal hardness (HU) when 1 mN was pushed into the particles was used as a measured value.

### (Deformation Amount of Particles)

This was measured with a universal hardness gauge. It was calculated from a particle diameter when a pushing-in load of 50 mN was applied and a particle diameter before applying the load.

### (Size of Particle Aggregate)

A size of the particle aggregate containing small-diameter particles was expressed by an average of 15 points in total by capturing surface images of the surface layer and measuring three maximum distances of particle aggregates containing the small-diameter particles at each of five arbitrary places.

### (Average Distance Between Particles)

An average distance between large-diameter particles is expressed by an average of 15 points in total by capturing surface images of the surface layer and measuring three respective distances between the large-diameter particles at each of five arbitrary places. An average distance between small-diameter particles and an average distance between other particles were measured also in the same manner.

### (Height of Convex Portion of Particle Portion)

This was measured by observing a cross section using a laser microscope (for example, a “VK-9510” manufactured by Keyence Corporation). A height of a convex portion of a large-diameter particle portion was expressed as a height from a surface of the surface layer at a portion in which particles were not present to a surface of the surface layer of a top portion at a portion in which the large-diameter particles were present. It was expressed by an average from measuring heights of respective convex portions in the large-diameter particle portion at five arbitrary positions. A height of a convex portion of a small-diameter particle portion and a height of a convex portion of other particle portions were measured also in the same manner.

### (Image Evaluation: Horizontal Stripes)

The manufactured charging roll was attached to a cartridge (black) of an actual machine (“CLJ 4525 dn” manufactured by HP), and images were reproduced with a 25% halftone density under an environment of 15° C.×10% RH. Evaluation was conducted at the beginning or after 20,000 sheets durability. Especially good results with no horizontal stripes in the image were evaluated as “⊚,” good results with few horizontal stripes in the image were evaluated as “◯,” and results with horizontal stripes appearing in the image due to a large influence on the image due to toner adhesion were evaluated as “x.”

### (Image Evaluation: Uniformity)

The manufactured charging roll was attached to a cartridge (black) of the actual machine (“CLJ 4525 dn” manufactured by HP), and images were reproduced with a 25% halftone density under an environment of 15° C.×10% RH. Evaluation was conducted at the beginning or after 20,000 sheets durability. Good results with no unevenness in the image were evaluated as good “◯,” and results with unevenness appeared in the image were evaluated as poor “x.”

### (Evaluation of Durability: Roll Contamination)

The manufactured charging roll was attached to a cartridge (black) of the actual machine (“CLJ 4525 dn” manufactured by HP), and an appearance of the roll was visually observed after 20,000 sheets durability under the environment of 15° C.×10% RH. In this case, a case in which white external additive contamination was adhered to the entire surface of the roll and an amount thereof obviously caused image failure was evaluated as a poor “x,” a case in which although slight stripe-like contamination was adhered to the surface of the roll, it was a contamination due to a white external additive adhered slightly and an amount thereof was of an extent that did not cause image failure was evaluated as good “◯,” and a case in which no stripe-like contamination was generated on the surface of the roll was evaluated as the best “⊚.”

### (The Number of Aggregates of Large-Diameter Particles)

Surface images of the surface layer were captured, and the number of aggregates (aggregates/mm²) of the large-diameter particles was measured at each of five arbitrary places, and then expressed as an average.

TABLE 1

| | | | Particle | Examples | | | | | | | | | | |
|---|---|---|---|---|---|---|---|---|---|---|---|---|---|---|
| | | | diameter (μm) | 1 | 2 | 3 | 4 | 5 | 6 | 7 | 8 | 9 | 10 | 11 |
| Composition | Binder resin | Nylon | | 100 | 100 | 100 | 100 | 100 | 100 | — | — | 100 | 100 | 100 |
| formulation | | Acryl | | — | — | — | — | — | — | 100 | 100 | — | — | — |
| (parts by | Large-diameter | Nylon <1> | 30 | 25 | 25 | — | 15 | 5 | 25 | 25 | — | — | — | 25 |
| mass) | particles | Nylon <2> | 20 | — | — | 20 | — | — | — | — | 20 | — | 25 | — |
| | | Nylon <3> | 50 | — | — | — | — | — | — | — | — | 35 | — | — |
| | Small-diameter | Nylon <4> | 5 | 25 | — | 25 | 25 | 25 | 5 | — | — | — | — | 25 |
| | particles | Nylon <5> | 10 | — | 25 | — | — | — | — | — | — | — | 25 | — |
| | | Silica <1> | 5 | — | — | — | — | — | — | 25 | — | — | — | — |
| | | Silica <2> | 3 | — | — | — | — | — | — | — | 20 | — | — | — |
| | | Silica <3> | 12 | — | — | — | — | — | — | — | — | 50 | — | — |

| Ultrasonic wave conditions (min.) | | | 10 | 10 | 10 | 10 | 10 | 10 | 10 | 10 | 5 | 10 | 10 |
|---|---|---|---|---|---|---|---|---|---|---|---|---|---|
| | Size of aggregates (μm) | | 40 | 40 | 30 | 40 | 40 | 40 | 40 | 6 | 50 | 30 | 40 |
| | Difference in particle diameter (μm) | | 25 | 20 | 15 | 25 | 25 | 25 | 25 | 17 | 35 | 10 | 25 |
| | Hardness ratio of particles | | 0.6 | 0.7 | 0.7 | 0.6 | 0.6 | 0.6 | 0.3 | 0.3 | 0.2 | 0.9 | 0.6 |
| | (large-diameter/small-diameter) | | | | | | | | | | | | |
| | Deformation amount (%) | | 50 | 50 | 50 | 50 | 50 | 50 | 50 | 50 | 50 | 50 | 85 |
| | Distance between large-diameter particles (μm) | | 60 | 60 | 60 | 150 | 300 | 60 | 60 | 60 | 120 | 60 | 60 |
| | Distance between small-diameter particles (μm) | | 20 | 20 | 20 | 20 | 20 | 40 | 20 | 7 | 40 | 20 | 20 |
| | Height of convex portion of | | 23 | 23 | 13 | 23 | 23 | 23 | 23 | 13 | 44 | 13 | 23 |
| | large-diameter particle portion (μm) | | | | | | | | | | | | |
| | Height of convex portion of | | 3 | 7 | 3 | 3 | 3 | 3 | 3 | 2 | 12 | 7 | 3 |
| | small-diameter particle portion (μm) | | | | | | | | | | | | |
| Evaluation | Image quality | Horizontal stripes | ⊚ | ⊚ | ⊚ | ⊚ | ⊚ | ⊚ | ⊚ | ⊚ | ⊚ | ◯ | ◯ |
| | | Uniformity | ◯ | ◯ | ◯ | ◯ | ◯ | ◯ | ◯ | ◯ | ◯ | ◯ | ◯ |
| | Durability | Roll contamination | ◯ | ◯ | ◯ | ◯ | ◯ | ◯ | ⊚ | ⊚ | ⊚ | ◯ | ◯ |

TABLE 2

| | | | Particle | Comparative examples | | | | | | | |
|---|---|---|---|---|---|---|---|---|---|---|---|
| | | | diameter (μm) | 1 | 2 | 3 | 4 | 5 | 6 | 7 | 8 |
| Composition | Binder resin | Nylon | | 100 | 100 | 100 | 100 | 100 | — | 100 | — |
| formulation | | Acryl | | — | — | — | — | — | 100 | — | 100 |
| (parts by | Large-diameter | Nylon <1> | 30 | 25 | — | — | 25 | — | 25 | 25 | 25 |
| mass) | particles | Nylon <2> | 20 | — | 45 | — | — | 35 | — | — | — |
| | | Nylon <3> | 50 | — | — | — | — | — | — | — | — |
| | Small-diameter | Nylon <4> | 5 | — | — | — | 3 | — | — | 60 | — |
| | particles | Nylon <5> | 10 | — | | 45 | — | — | — | — | — |
| | | Silica <1> | 5 | — | — | — | — | — | — | — | 25 |
| | | Silica <2> | 3 | — | — | — | — | — | — | — | — |
| | | Silica <3> | 12 | — | — | — | — | — | — | — | — |
| | Other particles | Nylon <6> | 60 | | | | | 53 | | | |
| | | Silica <4> | 2 | | | | | | 15 | | |

| Ultrasonic wave conditions (min.) | | | 10 | 10 | 10 | 10 | 10 | 10 | 10 | 2 |
|---|---|---|---|---|---|---|---|---|---|---|
| | Size of aggregates (μm) | | 40 | 30 | 20 | 40 | 80 | 35 | 60 | 60 |
| | Difference in particle diameter (μm) | | — | — | — | 25 | 40 | 28 | 25 | 25 |
| | Hardness ratio of particles | | — | — | — | 0.6 | 0.7 | 0.2 | 0.6 | 0.3 |
| | (large-diameter/small-diameter) | | | | | | | | | |
| | Deformation amount (%) | | 50 | 50 | 50 | 50 | 50 | 50 | 50 | 50 |
| | Distance between large-diameter particles (μm) | | 60 | 40 | — | 60 | 40 | 60 | 60 | 60 |
| | Distance between small-diameter particles (μm) | | — | — | 20 | 60 | — | — | 20 | 20 |
| | Distance between other particles (μm) | | — | — | — | — | 60 | 3 | — | — |
| | Height of convex portion of | | 23 | 13 | — | 23 | 13 | 23 | 23 | 23 |
| | large-diameter particle portion(μm) | | | | | | | | | |
| | Height of convex portion of | | — | — | 7 | 3 | — | — | 3 | 3 |
| | small-diameter particle portion (μm) | | | | | | | | | |
| | Height of conver portion of other particle portion(μm) | | — | — | — | — | 53 | 1.5 | — | — |
| Evaluation | Image quality | Horizontal stripes | ⊚ | ⊚ | X | ⊚ | ⊚ | ⊚ | ⊚ | ⊚ |
| | | Uniformity | X | X | ◯ | X | X | X | X | X |
| | Durability | Roll contamination | ◯ | ◯ | ◯ | ◯ | ◯ | ◯ | ◯ | ◯ |

TABLE 3

| | | | Particle | Comparative examples | | | | | | | | |
|---|---|---|---|---|---|---|---|---|---|---|---|---|
| | | | diameter (μm) | 1 | 12 | 13 | 14 | 15 | 16 | 17 | 7 | 18 |
| Composition | Binder resin | Nylon | | 100 | 100 | 100 | 100 | 100 | 100 | 100 | — | |
| formulation | | Acryl | | — | — | — | — | — | — | — | 100 | 100 |
| (parts by | Large-diameter | Nylon <1> | 30 | 25 | 25 | 25 | 25 | 25 | 25 | 25 | 25 | 25 |
| mass) | particles | Nylon <2> | 20 | — | — | — | — | — | — | — | — | — |
| | | Nylon <3> | 50 | — | — | — | — | — | — | — | — | — |
| | Small-diameter | Nylon <4> | 5 | 25 | 25 | 25 | 25 | 26 | 25 | 25 | — | — |
| | particles | Nylon <5> | 10 | — | | | — | — | — | — | — | — |
| | | Silica <1> | 5 | — | — | — | — | — | — | — | 25 | 25 |
| | | Silica <2> | 3 | — | — | — | — | — | — | — | — | — |
| | | Silica <3> | 12 | — | — | — | — | — | — | — | — | — |
| | Organic acids | citric acid | | — | 3 | — | — | — | 0.1 | 10 | — | 3 |
| | | oxalic acid | | — | — | 3 | — | — | — | — | — | — |
| | | formic acid | | — | — | — | 3 | — | — | — | — | — |
| | | acetic acid | | — | — | — | — | 3 | — | — | — | — |
| Ultrasonic wave conditions (min.) | | | | 10 | 0 | 0 | 0 | 0 | 0 | 0 | 10 | 0 |
| | Size of aggregates (μm) | | | 40 | 40 | 40 | 40 | 40 | 40 | 40 | 40 | 40 |
| | Number if aggregates of large- | | | 4 | 0 | 0 | 0 | 0 | 0 | 0 | 4 | 0 |
| | diameter particles (aggregates/mm²) | | | | | | | | | | | |
| | Difference in particle diameter (μm) | | | 25 | 25 | 25 | 25 | 25 | 25 | 25 | 25 | 25 |
| | Hardness ratio of particles | | | 0.6 | 0.6 | 0.6 | 0.6 | 0.6 | 0.6 | 0.6 | 0.3 | 0.3 |
| | (large-diameter/small-diameter) | | | | | | | | | | | |
| | Deformation amount (%) | | | 50 | 50 | 50 | 50 | 50 | 50 | 50 | 50 | 50 |
| | Distance between large-diameter particles (μm) | | | 60 | 120 | 120 | 120 | 120 | 100 | 150 | 60 | 60 |
| | Distance between small-diameter particles (μm) | | | 20 | 20 | 20 | 20 | 20 | 20 | 20 | 20 | 20 |
| | Height of convex portion of | | | 23 | 23 | 23 | 23 | 23 | 23 | 23 | 23 | 23 |
| | large-diameter particle portion(μm) | | | | | | | | | | | |
| | Height of convex portion of | | | 3 | 3 | 3 | 3 | 3 | 3 | 3 | 3 | 3 |
| | small-diameter particle portion(μm) | | | | | | | | | | | |
| Evaluation | Image | Horizontal stripes | Beginning | ⊚ | ⊚ | ⊚ | ⊚ | ⊚ | ⊚ | ⊚ | ⊚ | ⊚ |
| | quality | | After durability | ◯ | ⊚ | ⊚ | ⊚ | ⊚ | ⊚ | ⊚ | ◯ | ⊚ |
| | | Uniformity | Beginning | ◯ | ⊚ | ⊚ | ⊚ | ⊚ | ⊚ | ⊚ | ◯ | ⊚ |
| | | | After durability | ◯ | ⊚ | ⊚ | ⊚ | ⊚ | ⊚ | ⊚ | ◯ | ⊚ |

| | | | | | | | | | | |
|---|---|---|---|---|---|---|---|---|---|---|
| Durability | Roll contamination | ◯ | ◯ | ⊚ | ⊚ | ⊚ | ⊚ | ⊚ | ⊚ | ⊚ |

In Comparative examples 1 and 2, since predetermined small-diameter particles were not contained while predetermined large-diameter particles were contained, charging uniformity was insufficient and image uniformity was inferior. In Comparative example 3, since the predetermined large-diameter particles were not contained while the predetermined small-diameter particles were contained, a gap between the surface layer and the photosensitive drum was insufficient and horizontal stripes were generated in the image. In Comparative example 4, although the predetermined large-diameter particles and the predetermined small-diameter particles were contained, since the content of the predetermined small-diameter particles was excessively small, charging uniformity was insufficient and image uniformity was inferior. In Comparative example 5, since the predetermined small-diameter particles were not contained while the predetermined large-diameter particles and particles larger in diameter than the large-diameter particles were contained, charging uniformity was insufficient and image uniformity was inferior. In Comparative example 6, since the predetermined small-diameter particles were not contained while particles smaller in diameter than the predetermined small-diameter particles and the predetermined large-diameter particles were contained, charging uniformity was insufficient and image uniformity was inferior. In Comparative example 7, although the predetermined large-diameter particles and the predetermined small-diameter particles were contained, since the content of predetermined small-diameter particles was too large, a size of the aggregate containing the small-diameter particles was excessively large, and thus charging uniformity was insufficient and image uniformity was inferior. In Comparative example 8, although the predetermined large-diameter particles and the predetermined small-diameter particles were contained, since dispersion by ultrasonic waves was insufficient, a size of the aggregate containing the small-diameter particles were excessively large, and thus charging uniformity was insufficient and image uniformity was inferior.

In contrast, in Examples, since predetermined large-diameter particles and predetermined small-diameter particles were contained, a content of the predetermined small-diameter particles was within a predetermined range, and sizes of particle aggregates containing the small-diameter particles were within a predetermined range, a sufficient gap between the surface layer and the photosensitive drum was secured, charging uniformity was also satisfied, no horizontal stripes were generated in the image, and uniformity of the image was also excellent. Durability was also excellent. Thus, in a comparison between Examples, it was ascertained that when the hardness ratio between the large-diameter particle and the small-diameter particle was 0.5 or less, contamination during sustained use was further reduced and particularly durability was excellent.

From comparison of Example 1 with Examples 12 to 17, Example 7, Example 18, and Comparative example 8, when the surface layer further contains an organic acid, it was possible to restrict the size of particle aggregates containing small-diameter particles to be small without applying ultrasonic waves. In addition, aggregation of large-diameter particles can be prevented. In addition, a distance between large-diameter particles can be increased. Thereby, it was confirmed that an image quality was enhanced and roll contamination was reduced.

Although the embodiments and examples of the disclosure have been described above, the disclosure is not limited to the above embodiments and examples at all, and various modifications are possible without departing from the gist of the disclosure.

1. A charging roll for an electrophotographic device comprising:
a shaft body;
an elastic body layer formed on an outer periphery of the shaft body; and
a surface layer formed on an outer periphery of the elastic body layer, wherein
the surface layer comprises:
a binder resin;
large-diameter particles having an average particle diameter of 15 μm or more and 50 μm or less, wherein an average distance between the large-diameter particles is 60 μm or more;
small-diameter particles having an average particle diameter of 3 μm or more and less than 15 μm, wherein the small-diameter particles are silica particles, and an average distance between the small-diameter particles is 40 μm or less, and
an organic acid having a hydroxyl group, wherein
a content of the small-diameter particles is within a range of 5 to 50 parts by mass with respect to 100 parts by mass of the binder resin,
a content of the organic acid is within a range of 0.1 to 10 parts by mass with respect to 100 parts by mass of the binder resin,
a difference in average particle diameter between the large-diameter particles and the small-diameter particles is 10 μm or more,
a hardness of the large-diameter particles is lower than a hardness of the small-diameter particles, and
sizes of particle aggregates containing the small-diameter particles contained in the surface layer are 6 μm or more and 50 μm or less.
